(19) United States
(12) Patent Application Publication
(10) Pub. No.: US 2008/0021606 A1
(43) Pub. Date: Jan. 24, 2008

(54) Method For Calculating The Cumulative Interruption Of A Driving Period

(76) Inventors: Franz Kimmich, Schramberg (DE); Jan Schluter, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/570,735

(22) PCT Filed: Jun. 2, 2005
(86) PCT No.: PCT/EP05/52515

§ 371 Date: Dec. 15, 2006

(30) Foreign Application Priority Data
Jun. 25, 2004 (DE) 10 2004 031 041.6

(51) Int. Cl. G07C 5/08

(52) U.S. Cl. 701/35

(57) ABSTRACT

In a method for calculating a cumulative interruption of a driving period, associated with the identity (10) of a vehicle driver, the cumulative interruption of a driving period (Σti) of a determined driver is calculated as the respective accumulated duration of driving period interruptions (tᵢ₂, tᵢ₄ , tᵢ₅). The frequent process is very costly and time-intensive, especially if, for example, it is initiated by the insertion of a card data carrier into a new generation digital tachograph. In order to reduce the calculating time, a temporal reference mark (_{tRef}) to be continuously updated is inserted into the previous records and the accumulated driving period interruption (Σti) is calculated from said mark, in a positive chronological sequence, according to EG-VO No. 1360/2002.

### CROSS-REFERENCE TO RELATED APPLICATIONS

This application is a U.S. national stage application of International Application No. PCT/EP2005/052515 filed Jun. 2, 2005, which designates the United States of America, and claims priority to German application number DE 10 2004 031 041.6 filed Jun. 25, 2004 the contents of which are hereby incorporated by reference in their entirety.

### TECHNICAL FIELD

The invention relates to a method for calculating a cumulative driving period interruption by means of a control device which records activities of the driver of a vehicle, the cumulative driving period interruption of a specific driver being calculated as the respective accumulated time composed of driving period interruptions of at least 15 minutes duration since the end of the last accumulated driving period interruption of at least 45 minutes duration calculated in this way.

### BACKGROUND

The new generation of tachographs no longer records the activities of a driver of a vehicle, specifically driving, availability, interruption or rest or work, like a conventional tachograph by means of a paper diagram disk but instead stores activities and the associated time intervals on a data carrier in digital form. For this purpose, each driver of a vehicle is assigned a data card which has an internal memory in which driver-related data and the recorded data are stored. According to European Commission Regulation (EC) No. 1360/2002, a digital tachograph which is referred to as a control device in this document must be capable of calculating a cumulative driving period interruption which is also defined there so that specific minimum values and maximum values for times of rest and driving periods can be complied with. The necessary high level of precision of the calculations of these times, in particular the cumulative driving period interruption, involves a very high level of computation complexity and thus makes very large demands on the integrated computing unit. The possibility of a voltage failure greatly limits the size of the available time windows for the calculation of activities over the always large quantity of data, which is intensive in terms of computing time, with the result that the high level of precision which is required on the one hand for the calculation and the necessary data security which is required on the other constitute virtually irreconcilable peripheral conditions.

### SUMMARY

The invention has the object of providing a method for calculating the cumulative driving period interruption by means of a control device which requires a reduced amount of computing time and at the same time meets the stringent security requirements.

In order to achieve the object according to the invention it is proposed that in a first step of the calculation method recordings up to now are checked, in a negative time sequence starting from the present time, for the presence of an uninterrupted last time period of at least 45 minutes duration of the driving period interruption, when such a last time period is present the chronological end point of this time period is set as the chronological reference mark, in a second step the accumulated driving period interruption is set to zero, in a third step the accumulated time composed of the driving period interruption of at least 15 minutes duration up to the time when a total time of at least 45 minutes duration is reached is summed in a positive sequence starting from the chronological reference mark, in a fourth step the chronological end point which delimits the last time period of the summing in the positive sequence in the third step is set as a new reference mark, and the second, third and fourth steps are repeated successively until the present time is reached. In order to keep the computation complexity as low as possible, at a specific point in the past the method according to the invention sets a reference mark which marks the chronological start of the time period to be evaluated. In this way, the invention avoids the actual requirement to evaluate the entire recording time period of previous activities when calculating the cumulative driving period interruption. This is the only way that an acceptable access time and a power fail concept which can be implemented can be made possible. The advantages of the method according to the invention are greater the longer the time period of previous activity recordings. The continuous movement of the reference mark minimizes the time interval to be evaluated in terms of its length, as a result of which very short calculation times can be realized. At the same time, all the requirements of the EC regulation are met without compromise.

### BRIEF DESCRIPTION OF THE DRAWINGS

The invention is described in more detail below with reference to a specific exemplary embodiment for the sake of clarification, with reference to drawings, in which:

FIG. 1 is a simplified, schematic illustration of recordings which are assigned to an identity of a driver of a vehicle and which are recorded by means of a control device according to the invention, and

FIG. 2 is a schematic illustration of a sequence of the calculation of the cumulative driving period interruption.

### DETAILED DESCRIPTION

According to an embodiment, in a first step of the method, the time when the calculation starts is set as a present time. In one variant of the method which promotes the stability of a corresponding program run in an arithmetic unit, this present time can be assumed to be a constant value for the duration of the calculation.

A further possibility is to add an average time constant which is representative of the calculation duration to the present time during the program run before the end of the program is reached so that the entire evaluation still also comprises the running time of the calculation method. The most precise variant is to continuously define the present time as the time passes, even while the calculation method is running, so that the most precise result can always be obtained with the evaluation.

According to an embodiment, advantageously, when an uninterrupted last time period of at least 45 minutes duration of the driving period interruption is not present in the first step, the reference mark can firstly be set to the start of the recording of the activities. This refinement of the invention expediently takes into account the rather rare case in which, during the operating time of the control device, if appropriate with an assignment to an identity of a driver of a vehicle, a driving period interruption of a duration of 45 minutes has not yet occurred. In realistic operating situations, this case could also be dealt with acceptable computing times.

Large additional advantages are provided by an embodiment of the invention in which the control device has a first memory in which reference marks are stored in each case assigned to an identity, and before the first step or between the first and second steps of the calculation method the control device firstly checks for the presence of a reference mark which is assigned to the identity for which the calculation is to be carried out, and if an assigned reference mark for the calculation is present the stored assigned reference mark is used as the basis. In terms of practical implementation this means that drivers of vehicles who work in a fleet of vehicles and who prove their identity to a control device by means of their data card enjoy the advantage of a particularly short computing time for their cumulative driving period interruption if they have already initiated such a calculation by means of their data card not too long ago. Basically it is also conceivable that the driver of the vehicle will not initiate a calculation by means of a data card which is assigned to him but rather by means of some other external data memory which in some other way forms a connection to the control device which is suitable for transmitting data.

In order to precisely record the operation-related data of the vehicle it is appropriate if the control device is connected to a measured value transmitter which transmits a value which is correlated to the velocity of the vehicle to the control device for recording.

For identification of the driver of the vehicle or assignment of an identity to subsequent recordings to be able to take place it is appropriate if the control device has an external interface, in particular a data card receptacle with contact elements for transmitting data to which an external data carrier with a second memory, in particular a data card, can be connected. The data card does not primarily serve here for just identifying the driver of the vehicle but also for transmitting the recordings of previous activities which are assigned to the identity of the driver of the vehicle. It is necessary for this purpose for the external data carrier to contain, in the second memory, information about the identity of the driver of the vehicle.

An advantageous development provides for the control device to have operator control elements by means of which the driver of the vehicle can input information about activities to be recorded into the control device. At the same time it is expedient to define standard assignments which the control device defines when the recorded activities are expected to be input but this does not occur.

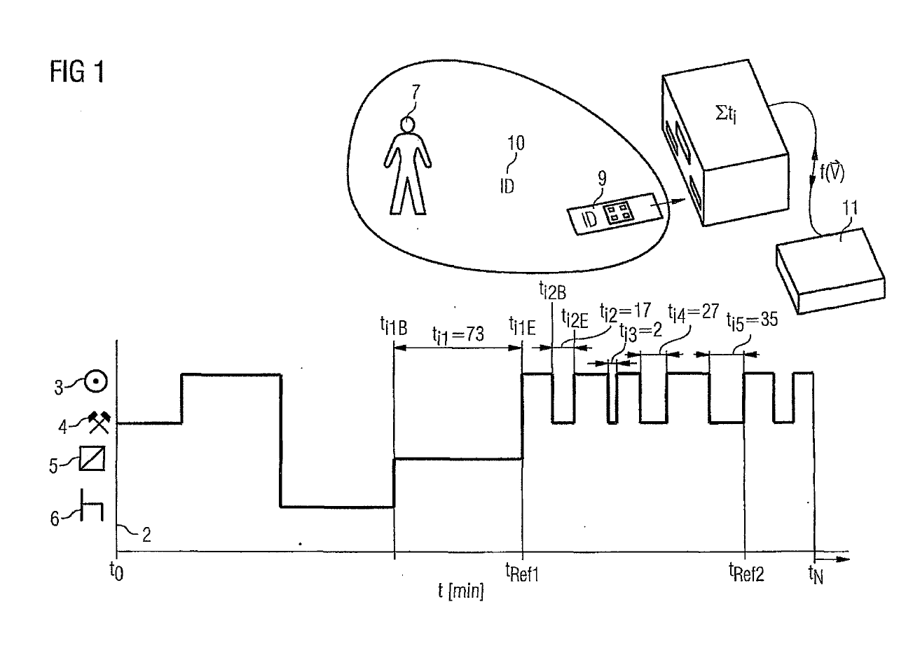

FIG. 1 is a schematic diagram of a possible recording profile, illustrating the completed profile of activities 1. The activities which are plotted on the ordinate 2 are driving 3, availability 4, rest 5 and work 6.

A driver 7 of a vehicle communicates his identity 10 to a control device 8 by means of a data card 9 and on the basis of this action initiates, inter alia, the calculation of the cumulative driving period interruption Σtᵢ. The control device 8 is connected to a measured value transmitter 11 which transmits to the control device 8 a measured value f(v) which is correlated to the velocity.

In the chronological profile of the recordings which are illustrated in the diagram, the activity 1 changes after a relatively long period from “work” to a 73 minute activity “sleep” (tᵢ₁) which ends at the time or the chronological reference mark t_{REF1}. After this, there is a sequence of “driving” alternating with “availability”. Starting from t_{REF1}, the cumulative driving period interruption Σtᵢ at the time t_{Ref2} is (tᵢ₂+tᵢ₄+tᵢ₅) 79 minutes. With the subsequent interruption of tᵢ₅=35 minutes, a Σtᵢ>45 minutes is obtained so that a new reference mark according to the invention (t_{Ref2}) according to the method according to the invention is set to the end of the last, summed time period.

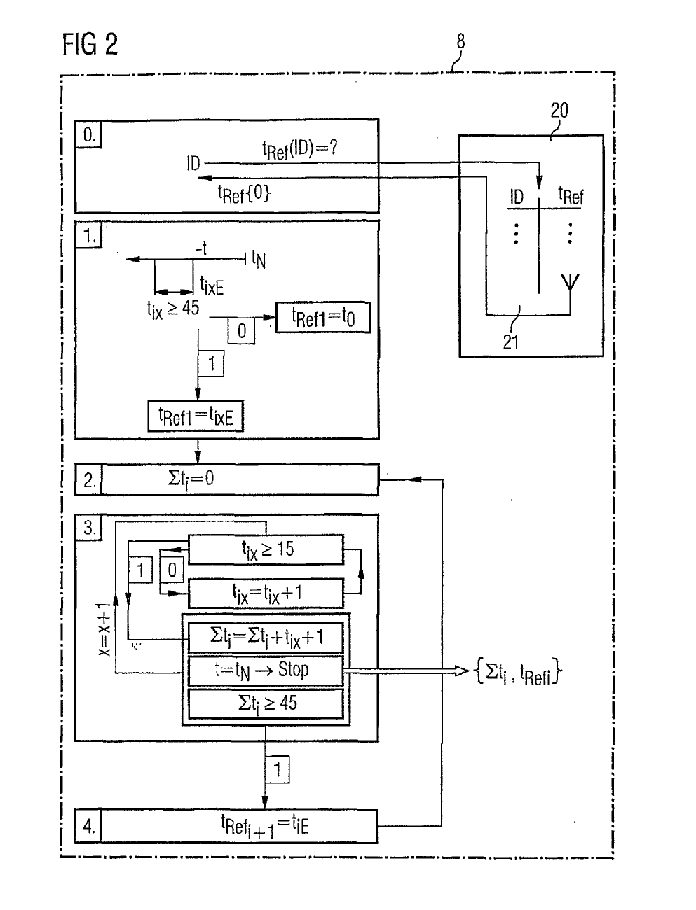

In the illustration in FIG. 2, the method according to the invention is divided into 5 steps, starting with 0 and ending with 4.

In the method step designated by 0, the control device 8 checks whether a reference mark t_{Ref} (ID) has already been determined for the identity 10 in the past. To do this, the control device 8 accesses an internal first memory 20 in which an assignment 21 of identities IDs to reference marks t_{Ref} is stored. If the result of this check is that there is no reference mark t_{Ref} present for the identity ID, according to the exemplary embodiment the method according to the invention changes over to a step designated by 1. If a reference mark t_{Ref} has already been determined earlier for the identity ID, which is an element of the assignment 21, the method is continued with the step designated by 2. The step which is designated by 0 is basically not a prerequisite for the calculation of a cumulative driving period interruption Σtᵢ according to the invention. Such a calculation can be made without reference to an identity ID so that expedient embodiments of the method can also start with the step designated by 1. This is the case in particular if, for example, the driver of a vehicle is driving the vehicle without, for example, having previously inserted a data card 9 into the device.

In the step of the method designated by 1, it is checked in a negative time sequence −t starting from the present time t_{N} whether an interrupted driving period interruption tᵢₓ which lasted longer than 45 minutes is present within previous recordings. If such a time period of 45 minutes or more is present, the method according to the invention sets, in accordance with the exemplary embodiment, a time mark t_{Ref1} to the end tᵢₓₑ which limits this driving period interruption in the positive time sequence. If there is no time period of uninterrupted driving period interruption of at least 45 minutes duration present in the previous recordings, the reference mark t_{Ref1} is set to the chronological start of the recordings t₀.

In a step of the method which is designated by 2, the cumulative driving period interruption Σtᵢ is firstly defined as 0 before subsequently entering the step of the method designated by 3.

Driving period interruptions of at least 15 minutes duration t_{iX} are summed in a positive time sequence starting from the time mark t_{Ref} until the sum Σtᵢ reaches or exceeds the duration of 45 minutes, after which the chronological end point of the last summand which is located in a positive time sequence is set as a new reference mark t_{refi+1}. The method repeats the process designated by 3 until the present time t_{N} is reached. At this point, the program sequence is interrupted (STOP) and the current assignment of the cumulative driving period interruption and the reference mark are used as the basis for the further recordings of the control device 8 and the calculations.

1. A digital tachograph for evaluating activities of a driver of a vehicle, the tachograph being operable to
record the activities of the driver of the vehicle, in particular driving, availability, rest and work, and the associated time intervals in a data memory,
calculate, by means of an integrated arithmetic unit, a cumulative driving period interruption as the respective accumulated time composed of driving period interruptions of at least 15 minutes duration since the end of the last accumulated driving period interruption of at least 45 minutes duration calculated in this way,
check the recordings up to now, in a negative sequence starting from a present time, for the presence of an uninterrupted, last time period of at least 45 minutes duration of the driving period interruption,
set, when such a last time period is present, the chronological end point of this time period as a chronological reference mark, and
calculates the cumulative driving period interruption in that, up to the present time, the tachograph successively
sets the cumulative driving period interruption to zero,
sums the accumulated time composed of the driving period interruption of at least 15 minutes up to the time when a total time of at least 45 minutes duration is reached, in a positive time sequence starting from the chronological reference mark,
and sets, as a new reference mark, the chronological end point which delimits the last time period of the summing in the positive time sequence.

2. The digital tachograph according to claim 1, wherein the control device sets the start of the calculation as a present time.

3. The digital tachograph according to claim 1, wherein, when an uninterrupted last time period of at least 45 minutes of the driving period interruption is not present, the tachograph sets the reference mark firstly to the start of the recording of the activities.

4. The digital tachograph according to claim 1, wherein the tachograph has a first memory in which reference marks are stored in each case assigned to an identity, and the tachograph firstly checks for the presence of a reference mark which is assigned to the identity for which the calculation is to be carried out, and if an assigned reference mark for the calculation is present the stored assigned reference marks is used as the basis.

5. The digital tachograph according to claim 1, wherein the tachograph is connected to a measured value transmitter which transmits a value which is correlated to the velocity of the vehicle to the tachograph for recording.

6. The digital tachograph according to claim 1, wherein the tachograph has an external interface, in particular a data card receptacle with contact elements for transmitting data to which an external data carrier with a second memory, in particular a data card, can be connected.

7. The digital tachograph according to claim 6, wherein the external data carrier contains, in the second memory, information about an identity of a driver of a vehicle, and the control device assigns the recordings to the identity specified on the data card.

8. The digital tachograph according to claim 1, wherein the tachograph has operator control elements by means of which the driver of the vehicle can input information about activities to be recorded into the control device.

9. The digital tachograph according to claim 1, wherein, during the calculation of the cumulative driving period interruption, the tachograph assigns said driving period interruption to an identity of a driver of a vehicle.

10. A method for evaluating activities of a driver of a vehicle using a tachograph, the method comprising the steps of:
recording the activities of the driver of the vehicle in associated time intervals in a data memory,
calculating a cumulative driving period interruption as the respective accumulated time composed of driving period interruptions of at least 15 minutes duration since the end of the last accumulated driving period interruption of at least 45 minutes duration,
checking the recordings up to now, in a negative sequence starting from a present time, for the presence of an uninterrupted, last time period of at least 45 minutes duration of the driving period interruption,
setting, when such a last time period is present, the chronological end point of this time period as a chronological reference mark, and
calculating the cumulative driving period interruption in that, up to the present time, the tachograph successively
sets the cumulative driving period interruption to zero,
sums the accumulated time composed of the driving period interruption of at least 15 minutes up to the time when a total time of at least 45 minutes duration is reached, in a positive time sequence starting from the chronological reference mark,
and sets, as a new reference mark, the chronological end point which delimits the last time period of the summing in the positive time sequence.

11. The method according to claim 10, wherein, when an uninterrupted last time period of at least 45 minutes of the driving period interruption is not present, the tachograph sets the reference mark firstly to the start of the recording of the activities.

12. The method according to claim 10, wherein, during the calculation of the cumulative driving period interruption, the tachograph assigns said driving period interruption to an identity of a driver of a vehicle.

13. A digital tachograph for evaluating activities of a driver of a vehicle, comprising
a data memory for recording the activities of the driver of the vehicle,
an integrated arithmetic unit for calculating a cumulative driving period interruption as the respective accumulated time composed of driving period interruptions of at least 15 minutes duration since the end of the last accumulated driving period interruption of at least 45 minutes duration,
means for checking the recordings up to now, in a negative sequence starting from a present time, for the presence of an uninterrupted, last time period of at least 45 minutes duration of the driving period interruption,
means for setting, when such a last time period is present, the chronological end point of this time period as a chronological reference mark, and
means for calculating the cumulative driving period interruption in that, up to the present time, the tachograph successively
sets the cumulative driving period interruption to zero,
sums the accumulated time composed of the driving period interruption of at least 15 minutes up to the time when a total time of at least 45 minutes duration is reached, in a positive time sequence starting from the chronological reference mark,
and sets, as a new reference mark, the chronological end point which delimits the last time period of the summing in the positive time sequence.

14. The digital tachograph according to claim 13, the tachograph has a first memory in which reference marks are stored in each case assigned to an identity, and the tachograph firstly checks for the presence of a reference mark which is assigned to the identity for which the calculation is to be carried out, and if an assigned reference mark for the calculation is present the stored assigned reference mark is used as the basis.

15. The digital tachograph according to claim 13, wherein the tachograph is connected to a measured value transmitter which transmits a value which is correlated to the velocity of the vehicle to the tachograph for recording.

16. The digital tachograph according to claim 13, wherein the tachograph has an external interface, in particular a data card receptacle with contact elements for transmitting data to which an external data carrier with a second memory, in particular a data card, can be connected.

17. The digital tachograph according to claim 16, wherein the external data carrier contains, in the second memory, information about an identity of a driver of a vehicle, and the control device assigns the recordings to the identity specified on the data card.

18. The digital tachograph according to claim 13, wherein the tachograph has operator control elements by means of which the driver of the vehicle can input information about activities to be recorded into the control device.

19. The digital tachograph according to claim 13, wherein, during the calculation of the cumulative driving period interruption, the tachograph assigns said driving period interruption to an identity of a driver of a vehicle.

20. The digital tachograph according to claim 13, wherein, during the calculation of the cumulative driving period interruption, the tachograph assigns said driving period interruption to an identity of a driver of a vehicle.
